(19) United States
(12) Patent Application Publication
(10) Pub. No.: US 2011/0286043 A1
(43) Pub. Date: Nov. 24, 2011

(54) FORM PROCESSING SYSTEM, OCR DEVICE, FORM CREATION DEVICE, AND COMPUTER READABLE MEDIUM

(75) Inventors: Shoichi HAGISAWA, Ishikawa (JP); Go DOJO, Ishikawa (JP); Toshihiko SUGITA, Ishikawa (JP); Yoshinori KUWAMURA, Ishikawa (JP)

(73) Assignee: PFU LIMITED, Ishikawa (JP)

(21) Appl. No.: 13/112,927

(22) Filed: May 20, 2011

(30) Foreign Application Priority Data
May 24, 2010 (JP) 2010-118807
Dec. 27, 2010 (JP) 2010-289066

(51) Int. Cl. G06F 3/12

(52) U.S. Cl. 358/1.15

(57) ABSTRACT

There is provided a form processing system including a form creation device and an OCR device, wherein the form creation device includes a layout generation unit that generates layout information denoting a layout of a form and a layout transmission unit that transmits the layout information generated to the OCR device, and the OCR device includes a layout acquisition unit that acquires the layout information transmitted from the form creation device and an OCR processing unit that performs OCR processing on image data of the form read by a scanner, based on the layout information acquired.

### CROSS-REFERENCE TO RELATED APPLICATIONS

This application is based on and claims priority under 35 USC 119 from Japanese Patent Application No. 2010-118807 filed May 24, 2010 and Japanese Patent Application No. 2010-289066 filed Dec. 27, 2010.

### BACKGROUND OF THE INVENTION

### Field of the Invention

The present invention relates to a form processing system, OCR device, form creation device, and computer readable medium.

### SUMMARY OF THE INVENTION

According to an aspect of the invention, there is provided a form processing system including a form creation device and an OCR device, wherein the form creation device includes a layout generation unit that generates layout information denoting a layout of a form and a layout transmission unit that transmits the layout information generated to the OCR device, and the OCR device includes a layout acquisition unit that acquires the layout information transmitted from the form creation device and an OCR processing unit that performs OCR processing on image data of the form read by a scanner, based on the layout information acquired.

### BRIEF DESCRIPTION OF THE DRAWINGS

Exemplary embodiments of the present invention will be described in detail based on the following figures, wherein:

FIG. 1 is an explanatory diagram showing outlined connections in a form processing system;

FIG. 2 is a functional block diagram showing a configuration of a form creation device;

FIG. 3 is an explanatory view showing one example of a form layout;

FIG. 4 is an explanatory table of layout information;

FIG. 5 is a functional block diagram showing a configuration of an OCR device;

FIG. 6 is an explanatory table of reform information;

FIG. 7 is a sequence diagram showing a flow of overall processing in testing of a form processing method;

FIG. 8 is a sequence diagram showing a flow of overall processing in operation of the form processing method;

FIG. 9 is an illustrative view showing a form having a layout whose portion is variable;

FIG. 10 is a functional block diagram showing a configuration of a form creation device 110 in a first variant;

FIG. 11 is a functional block diagram showing a configuration of an OCR device 120 in the first variant;

FIG. 12 is an illustrative view showing a table stored in a storage device 204 in the first variant; and

FIG. 13 is a sequence diagram showing a flow of overall processing during an operation in the first variant.

### DESCRIPTION OF THE PREFERRED EMBODIMENTS

The following will describe in detail an exemplary embodiment of the present invention with reference to the accompanying drawings. It is understood that dimensions, materials, and other specific numerals given in the present embodiment are illustrative of the present invention for ease of explanation unless otherwise specified and details contained therein are not to be construed as limitations on the present invention. It is to be noted that identical reference numerals are given to the essentially the identical components in the present specification and drawings, and description thereof will not be repeated here.

(Form Processing System 100)

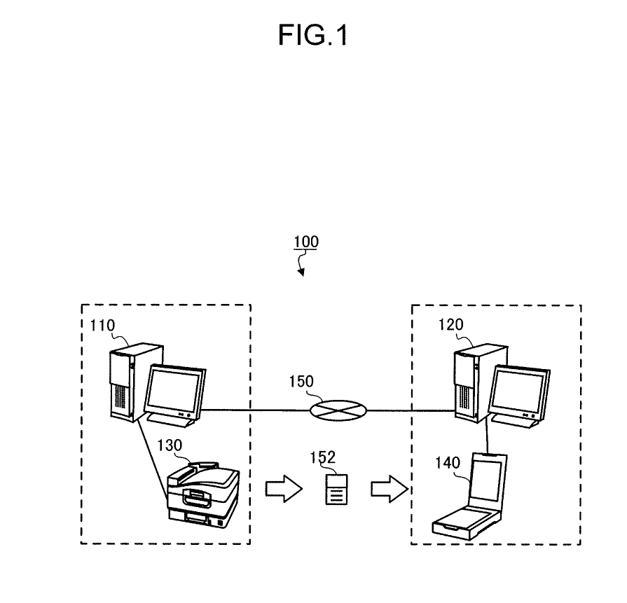

FIG. 1 is an explanatory diagram showing outlined connections in the form processing system 100. The form processing system 100 includes a form creation device 110, an OCR device 120, a printer 130, and a scanner 140. The form creation device 110 is connected with the OCR device 120 via a communication network 150 such as the internet, a local area network (LAN), or a dedicated line. The form creation device 110 is also connected with the printer 130 and the OCR device 120 is connected with the scanner 140 via, for example, the LAN.

If having received a user's input for creation of a layout, the form creation device 110 generates layout information that denotes the layout of a form 152. Then, the printer 130 prints the form 152 having the generated layout information. The user writes down, for example, job-related information onto the printed-out form 152 by handwriting, imprinting, or stamping. If the form 152 is completed in writing, the scanner 140 reads the form 152 having the information written on it, which image data then undergoes OCR processing in the OCR 120, which thereby acquires the information written on the form 152.

For example, a form creation device is proposed that automatically generates a format of the form in accordance with the model of the OCR device, the number of line fields, and the number of characters entered manually by the user. However, such a form creation device only automatically adjusts the character frame and the form size of a form to be created, leading to a troublesome job of identifying the OCR device model etc. Furthermore, in the case of reading forms of the same layout repeatedly, the user must notify the OCR device of, for example, a position at which a target form is read, in order to improve the accuracy in OCR processing.

In the form processing system 100 according to the present embodiment, layout information, if generated in the form creation device 110, is used in common in OCR processing by the OCR device 120. Therefore, in the present form processing system 100, it is possible to improve the accuracy in OCR processing while reducing work burdens on the user. The following will describe in detail the configurations of the respective form creation device 110 and OCR device 120 in this order.

(Form Creation Device 110)

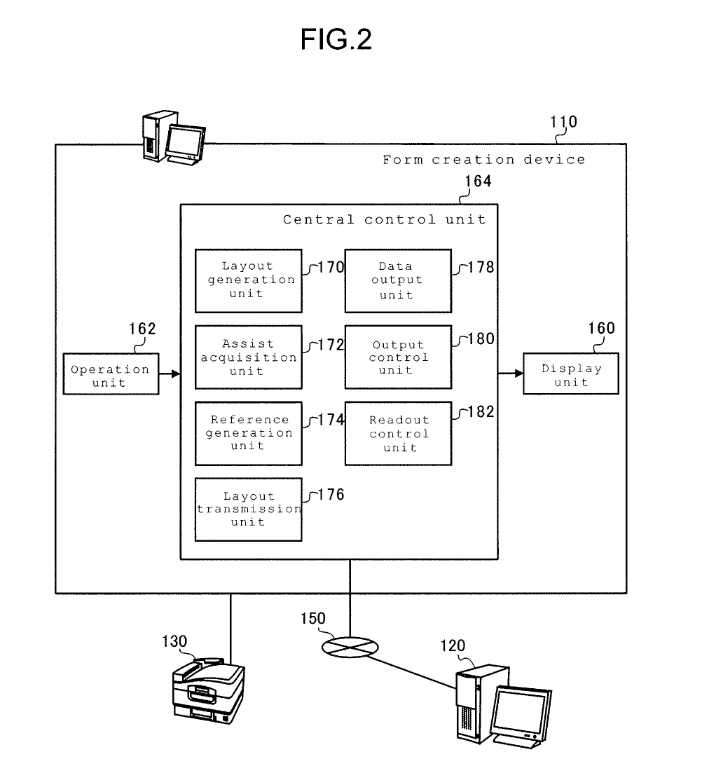

FIG. 2 is a functional block diagram showing the configuration of the form creation device 110. The form creation device 110 includes a display unit 160, an operation unit 162 and a central control unit 164.

The display unit 160 is constituted of an LCD, an organic electro luminescence display, etc. The operation unit 162 is constituted of a touch panel mounted on the display surface of the display unit 160, a keyboard mounted with a plurality of operation keys, a pointing device such as a mouse, an arrow key, or a joystick. The form creation device 110 displays a layout creation screen on the display unit 160, to receive a user's input through the operation unit 162, thereby generating a layout of the form 152.

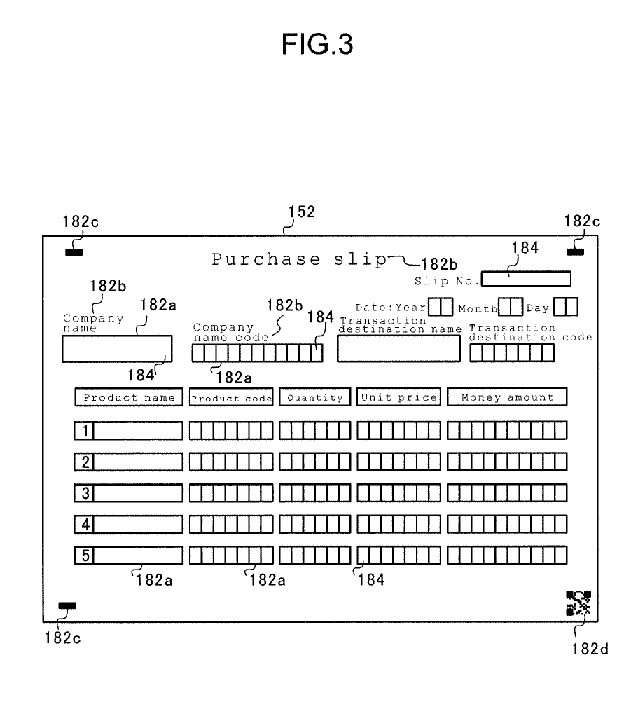

FIG. 3 is an explanatory view showing one example of a layout. As shown in FIG. 3, the layout of form 152, for example, a character frame 182a, a character 182b, a reference mark 182c, a barcode 182d is set. It is to be noted that the reference marks 182c provide references for the direction and layout position of the form 152 when the OCR device 120 performs OCR processing on image data read by the scanner 140. Further, the barcode 182d is obtained by encoding arbitrary information in accordance with predetermined rules and denotes, for example, a form ID that identifies the form 152.

The form creation device 110 generates a layout such as shown in FIG. 3 in response to user's input through the operation unit 162. In this case, the form 152 includes a plurality of input regions 184 summarizing input aspects with regularities. The input region 184 is enclosed by, for example, the character frame 182a. The input region 184 is capable of setting in it the type of characters (alphabet, number, Japanese, symbol, etc.), the attributes (handwritten character, type, etc.), etc. assumed to be written.

The central control unit 164 controls the entire form creation device 110 by using a semiconductor integrated circuit incorporating a central processing unit (CPU), an ROM storing a program etc., and an RAM serving as a working area, etc. Further, the central control unit 164 functions also as a layout generation unit 170, an assist acquisition unit 172, a reference generation unit 174, a layout transmission unit 176, a data output unit 178, an output control unit 180, and a readout control unit 182.

The layout generation unit 170 generates layout information that denotes the layout of the form 152 in accordance with a layout set by a user's input through the operation unit 162.

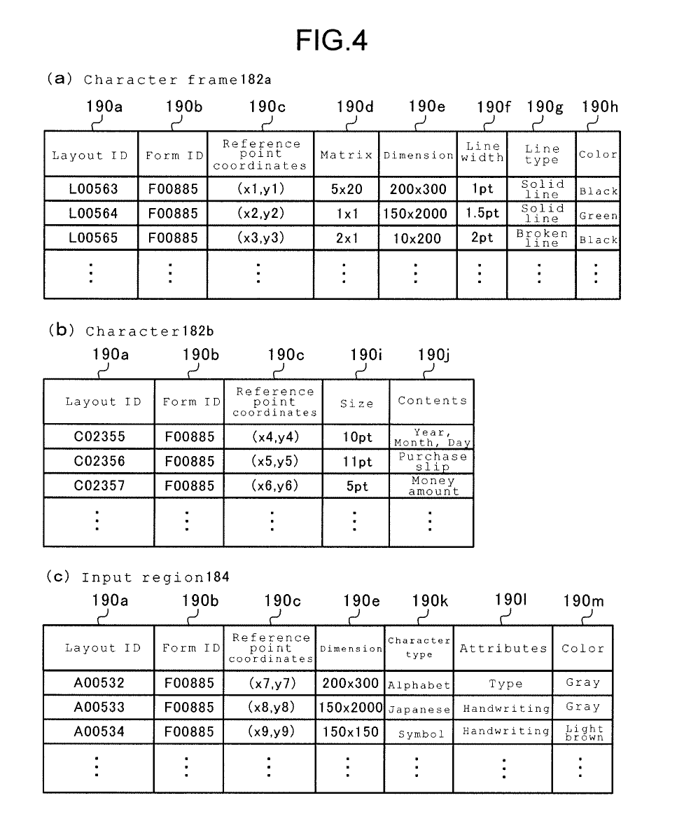

FIG. 4 is an explanatory table of layout information. Among the layout information, in particular, FIG. 4A shows a character frame 182a, FIG. 4B shows a character 182b, and FIG. 4C shows an input region 184. As shown in FIG. 4A, the layout information of the character frame 182a is made of, for example, a layout ID 190a, a form ID 190b, a reference point coordinate 190c, a matrix 190d, a dimension 190e, a line width 190f, a line type 190g, a color 190h, etc.

The layout ID 190a is identification information that identifies the corresponding character frame 182a. The form ID 190b is identification information that identifies layout information which the form 152 is based on. The reference point coordinate 190c denotes coordinates of a reference point of the corresponding character frame 182a, for example, the lower left point of the character frame 182a. In the present embodiment, the coordinate system has an x-axis and a y-axis as its horizontal and vertical directions respectively on the assumption that the lower left reference mark 182c of the form 152 is its origin. The matrix 190d denotes the respective numbers of rows and columns in a case where a region surrounded by the corresponding character frame 182a is subdivided. Further, the layout information (characteristics information) may set the character frame 182a not in table units but in units of a block obtained by subdividing the region surrounded by this character frame 182a.

The size 190e denotes, for example, the width and the height of a block obtained by subdividing a table surrounded by the character frame 182a and, if the width and the height differ with the different rows and columns, is set for each of the rows or columns. Similarly, if the line width 190f, the line type 190g, and the color 190h of the character frame 182a differ with the different rows and columns, they are set for each of the rows or columns. In this case, if the line width 190f, the line type 190g, and the color 190h of the character frame 182a are different between the adjacent rows or columns, in the sandwiched character frame 182a, priority is given to the settings that are later made by a user's input. Further, besides the character frame 182a closed by ruled lines on all four sides, the rules lines can be set independently.

As shown in FIG. 4B, the layout information of the character 182b is made of, for example, the layout ID 190a, the form ID 190b, the reference point coordinate 190c, a size 190i, a content 190j, etc. The size 190i denotes the size of the character 182b and the content 190j is the character 182b itself actually printed, such as “purchase slip”, “year”, “month, or “day”. Further, if the character 182b is variable because it happens to be, for example, a sequential slip number or a customer number which is different with each customer, the layout information may contain variable information that denotes change rules of the character 182b.

As shown in FIG. 4C, the layout information of the input region 184 is made of, for example, the layout ID 190a, the form ID 190b, the dimension 190e, a character type 190k, an attribute 190l, a color 190m, etc. The character type 190k denotes, as described above, the type of a character assumed to be written and can set, for example, an alphabet, a number, a Hiragana, a Katakana, a symbol, Japanese, etc. The attribute 190l can set a handwritten character if handwriting is employed in writing, a type if printing or data sealing is employed, etc.

The layout information shown in FIG. 4 is just one example and contains the reference mark 182c and the barcode 182d as well as various information settings of various elements that can be written in the form 152.

The assist acquisition unit 172 acquires assist information transmitted from the later-described OCR device 120. If the assist acquisition unit 172 has acquired assist information, the layout generation unit 170 can generate layout information based on the assist information. The assist information contains algorithm information about an algorithm used in the OCR processing unit in the OCR device 120, which information may be, for example, the model name of the OCR device 120 or the name or version of OCR processing software used in the OCR processing unit in the OCR device 120.

The layout generation unit 170 applies restrictions on the layout information in accordance with the algorithm information acquired by the assist acquisition unit 172. For example, in the case of allocating the character frame 182a in accordance with a user's input, the layout generation unit 170 provides a lower limit value on the line width 190f of that character frame 182a. If the algorithm information is the name and the version of the OCR processing software, this lower limit value is set based on a performance of an algorithm identified by those OCR processing software and version.

Similarly, based on the algorithm information, the layout generation unit 170 applies restrictions on set items such as the size 190i and the location (reference point coordinate 190c) of the reference mark 182c, the size 190i of the barcode 182d, a dropout color not read by the scanner 140, the character type 190k, and the attribute 190l. Further, if the location of elements such as the character frame 182a is instructed by the user, the layout generation unit 170 may set on the basis of the algorithm information the initial values of the aforementioned set items contained in the layout information of those elements.

This configuration employing algorithm information reduces the number of times of repeating operations to conduct tests for confirmation of the accuracy in OCR processing on the form 152 and modifying the layout information based on the test results of the OCR processing, thereby greatly mitigating the work burdens on the user.

The reference generation unit 174 generates reference data that provides a reference for comparison to the results of OCR processing in the OCR device 120, based on the layout information generated by the layout generation unit 170. The reference data will be described later.

The layout transmission unit 176 transmits the layout information and the reference data to the OCR device 120. The data output unit 178 provides the printer 130 with the layout information after converting it into a format appropriate for printing out.

In a case where the form 152 is to be printed, the output control unit 180 controls the printer 130 so that it may print under predetermined printing conditions. Not limited to the case of directly controlling the printer 130, the output control unit 180 may provide the printer 130 with control information such as printing conditions that prohibits changes so that the printer 130 can set the printout conditions based on the control information.

If, for example, reduced printing is conducted owing to a careless change in printout conditions in the printer 130, the OCR processing accuracy may possibly be deteriorated due to a reduction in character size or line width in the printed form 152. Such a situation can be avoided by the output control unit 180 conducting control on the printer 130 so that it may perform printing under the predetermined printout conditions.

The readout control unit 182 provides the scanner 140 with specification information that specifies a resolution with which the scanner 140 reads the form 152 to convert it into image data as well as an application and commands to be executed after the readout, through the communication network 150. Not limited to such a case of providing through the communication network 150, the readout control unit 182 may embed the specification information in the form 152 as, for example, the barcode 182d so that the scanner 140 can acquire this specification information from that barcode 182d.

By such a configuration of including the readout control unit 182, it is possible to generate image data at a resolution appropriate for the OCR processing and to correct the generated image data by using applications and commands of the scanner 140, thereby further improving the OCR processing accuracy.

(OCR Device 120)

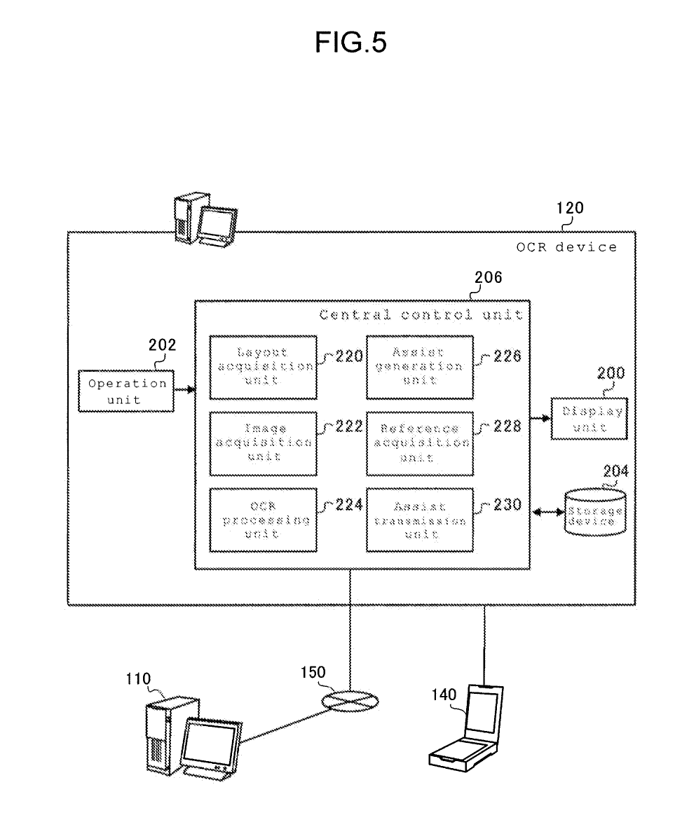

FIG. 5 is a functional block diagram showing a configuration of the OCR device 120. The OCR device 120 includes a display unit 200, an operation unit 202, a storage device 204 and a central control unit 206.

The display unit 200 is constituted of an LCD, an organic EL display, etc. The operation unit 402 is constituted of a touch panel mounted on a display surface of the display unit 200, a keyboard mounted with a plurality of operation keys, a pointing device such as a mouse, an arrow key, or a joystick.

The storage device 204 stores layout information etc., being constituted of a hard disk drive (HDD), a flash memory, a nonvolatile random access memory (RAM), etc. In the present embodiment, the storage device 204 is formed integrally with the OCR device 120 but not restricted to this aspect and may be, for example, a separate network attached storage (NAS) or an external HDD or universal serial bus (USB) memory.

The central control unit 206 controls the entire OCR device 120 by using a semiconductor integrated circuit incorporating a central processing unit (CPU), an ROM storing a program etc., and an RAM serving as a working area, etc. Further, the central control unit 206 functions also as a layout acquisition unit 220, an image acquisition unit 222, an OCR processing unit 224, an assist generation unit 226, a reference acquisition unit 228, and an assist transmission unit 230.

The layout acquisition unit 220 acquires layout information transmitted from the form creation device 110 and stores it in the storage device 204.

The image acquisition unit 222 acquires image data generated by reading the form 152 from the scanner 140.

The OCR processing unit 224 reads the form 152's form ID described in the shape of the barcode 182d etc., by using as a reference, for example, the position of the reference mark 182c in an image given by the image data acquired by the image acquisition unit 222. Further, the OCR processing unit 224 reads the layout information containing that form ID from the storage device 204 and, based on the read layout information, conducts OCR processing on the image data of the form 152 read by the scanner 140 (processing to extracts contents such as characters and numbers denoted by the image data from this image data).

The OCR device 120 in the present embodiment conducts OCR processing based on layout information acquired from the form creation device 110, so that it is possible to know, for example, a position of the character frame 182a and a position at which the written information is read, thereby improving the accuracy in OCR processing. Further, the layout information generated in the form creation device 110 is used also in the OCR device 120 in common, so that the user need not perform the same setting both in the form creation device 110 and the OCR device 120 and so is relieved of heavy work burdens. Moreover, also in the case of modifying the layout information in order to meet a need to improve the OCR processing accuracy based on specification changes and the results of the OCR processing for the once printed form 152, similarly, the layout information modified in the form creation device 110 can be used in both of the form creation device and the OCR device 120, thereby mitigating the work burdens on the user.

Further, the layout information contains variable information that defines a variable form capable of changing, for example, the shape, the size 190i, the location, the number of subdivisions, etc. about the input region 184 in the form 152.

If no measures are taken in handling of such a variable form, the OCR processing unit 224 will have to estimate its input region 184 based on only the image data, so that appropriate OCR results cannot be obtained in some cases. To solve this problem, in the present embodiment, if the form creation device 110 has determined the shape, the size 190i, the location, the number of subdivisions, etc. of the variable information input region 184 in the layout information in response to a user's input and then the data output unit 178 has output to the printer 130 the layout information containing the determined variable information input region 184, the layout transmission unit 176 is triggered by the output by the data output unit 178, to transmit to the OCR device 120 the layout information containing the determined input region 184. Further, in a case where the printer 130 is to determine the shape, the size 190i, the location, the number of subdivisions, etc. of the input region 184, the layout transmission unit 176 may be triggered by actual printout of the form 152 from the printer 130, to transmit the layout information containing this determined input region 184 to the OCR device 120.

In such a configuration, the OCR device 120 has a decided input region 184 in the layout information, so that it is possible to improve the OCR accuracy based on the accurate information of the input region 184 and reduce processing loads because the OCR processing target regions can be narrowed down.

Further, the layout information in this case may be the image data of the layout of the form 152 in accordance with the user's input. For example, the OCR device 120 corrects the image data of the form 152 read with the scanner 140 by matching, for example, its ruled line position etc. with the image data, which is the layout information also, and then conducts OCR processing on it. Such a configuration also improves the accuracy in OCR processing.

The assist generation unit 226 generates assist information that assists generation of layout information. The generated assist information contains also reform information that denotes points to be reformed in the layout information. The algorithm information among the assist information has been described already, so that the following will describe in detail the reform information.

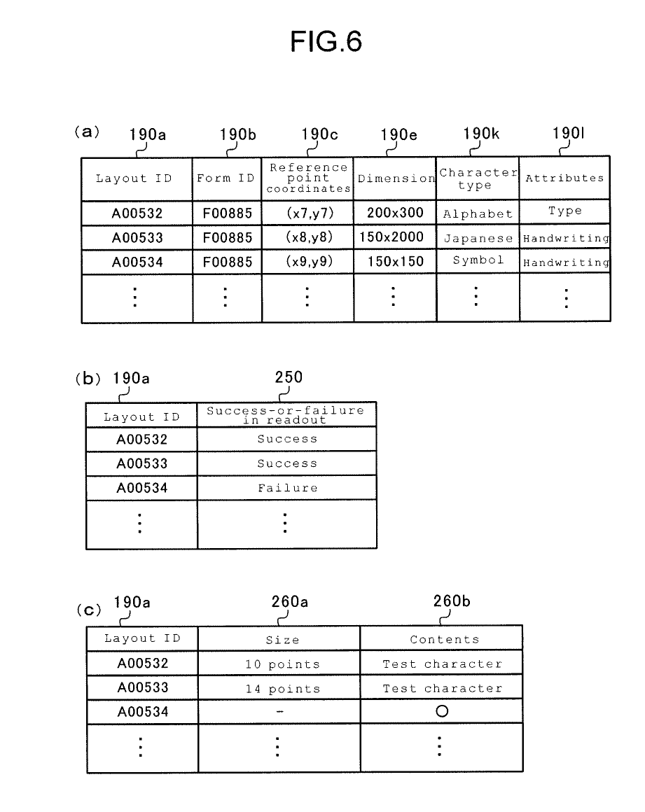

FIG. 6 is an explanatory table of reform information. In particular, FIG. 6A shows one example of the layout information, FIG. 6B shows one example of the reform information, and FIG. 6C shows one example of the reference data.

The assist generation unit 226 refers to such layout information about the input region 184 as shown in, for example, FIG. 6A, which has been acquired by the layout acquisition unit 220. Such layout information has already been described with reference to FIG. 4C, and repetitive description on it will be omitted.

Further, the assist generation unit 226 confirms whether written information is read successfully (success-or-failure in readout), which is denoted in the referenced layout information as a result of OCR processing by the OCR processing unit 224, about the subdivided input region 184 in which the written information should be able to be read. For example, in the case of reading handwritten characters, the OCR processing unit 224 crosschecks them against a reference character registered in the OCR processing software to compare a predetermined threshold value and an index value that denotes the degree of agreement with the characters decided to be most agreed with the reference character, thereby deciding the success-or-failure in readout. The threshold value can be changed through a user's input.

As shown in FIG. 6B, the assist generation unit 226 generates reform information that correlates the layout ID 190a which denotes the subdivided input region 184 in the layout information and the success-or-failure in readout (success-or-failure-in-readout 250) with each other, based on the results of the OCR processing.

In such a manner, as a result of OCR processing, for example, the reform information denotes a failure in readout in the subdivided input region 184 in which written information should originally be able to be read. Based on the reform information, the layout generation unit 170, for example, fills with a red color the subdivided input region 184 in which readout failed or reddens the character frame 182a that surrounds this subdivided input region 184, thereby prompting the user for reformation. Then, in response to a user's input, the layout information is modified, for example, the input region 184 or the size 190i of the character 182b is increased, to improve the accuracy in OCR processing.

In such a configuration of using the reform information, the success-or-failure in readout of written information is automatically presented, to eliminate the need for confirming it for each of the input regions 184, thereby mitigating the work burdens on the user and also avoiding a situation of overlooking points that need to be reformed.

Further, reference data generated by the reference generation unit 168 in the aforementioned form creation device 110 can be used to make the reform information more useful for the purpose of efficient reformation. The reference data generated by the reference generation unit 174 is not contained in the layout information and used in a test to confirm the accuracy in OCR processing. The reference data contains the layout ID 190a which denotes the subdivided input region 184 as well a size 260a of a character and a content 260b to be written by the user into the subdivided input region 184 for testing as shown in, for example, FIG. 6C.

In this case, a character having, for example, the size 260a or the content 260b defined in reference data beforehand is written into the subdivided input region 184 in the form 152. Further, besides handwritten characters, any character defined in the reference data may be printed with the printer 130. In this case, no matter whether the character is well written or not by the user, the OCR processing accuracy is improved by securely detecting a failure in readout caused by distortion etc. in an image generated by the scanner 140. Then, the image acquisition unit 222 in the OCR device 120 acquires the image data of that form 152 via the scanner 140.

The reference acquisition unit 228 acquires reference data transmitted by the layout transmission unit 176. The assist generation unit 226 generates reform information based on the reference data acquired by the reference acquisition unit 228 and the results of OCR processing.

The assist generation unit 226 generates reform information by comparing the reference data which denotes a character etc. whose, for example, size 260a or content 260b is defined and the results of OCR processing on image data of the form 152 in which characters etc. are actually written. The thus generated reform information is transmitted by the later-described assist transmission unit 230 to the form creation device 110. The form creation device 110 modifies layout information based on the reform information. In such a configuration to use the reference data, it is possible to conduct detailed comparison on character misrecognition etc., thereby improving accuracy in reformation of the layout information.

As described above, by using assist information such as the algorithm information and the reform information, information that can be known on the side of the OCR device 120 can be used in common also by the form creation device 110, so that the layout generation unit 170 in the form creation device 110 can generate layout information on which OCR processing can be performed easily.

The assist transmission unit 230 transmits assist information generated by the assist generation unit 226 to the form creation device 110.

The form creation device 110 and the OCR device 120 hereinbefore described improve the accuracy in OCR processing while greatly reducing work burdens on the user. Further, the present invention will provide a form creation program causing a computer to function as the form creation device 110, an OCR processing program causing it to function as the OCR device 120, and a computer-readable storage medium storing the form creation program or the OCR processing program such as a flexible disk, a magneto-optical disk, an ROM, an EPROM, an EEPROM, a compact disk (CD), a digital versatile disk (VDV), or a blue-ray disc (BD). Here, the program refers to data processing means described in an arbitrary language or description method.

Further, the form creation program and the OCR processing program may be stored in an arbitrary application program server connected to the form creation device 110 or the OCR device 120 via the communication network 150 so that all or part of them can be downloaded as required.

(Form Processing Method)

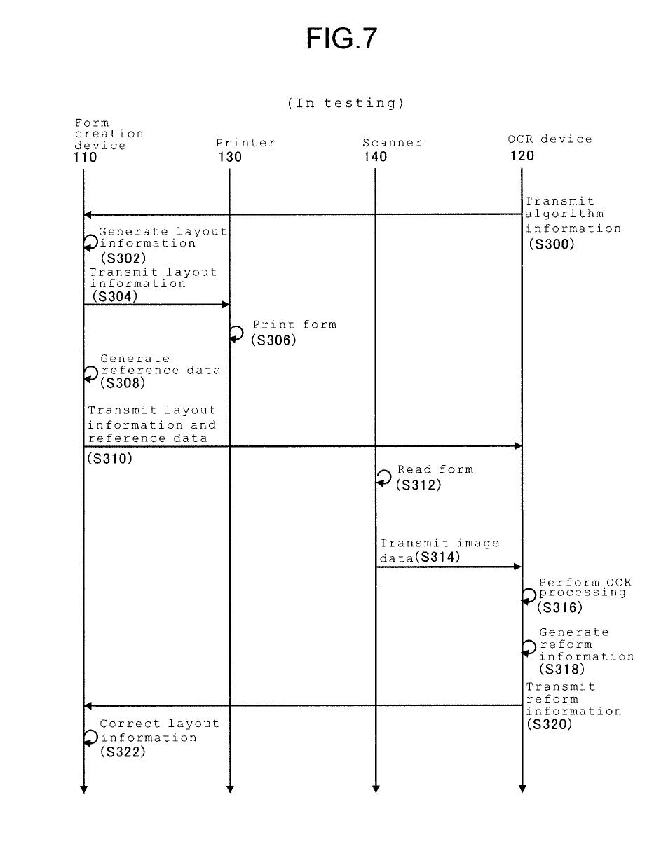

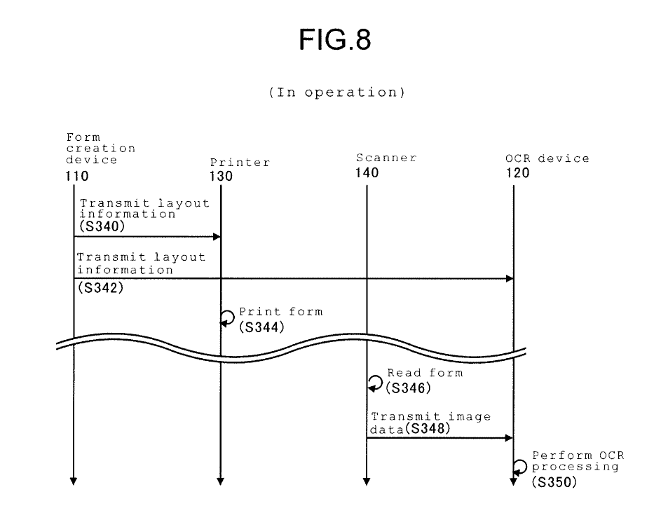

Next, a description will be given of the form processing method for operation of the aforementioned form processing system including the form creation device 110 and the printer 130. FIG. 7 is a sequence diagram showing the flow of overall processing in testing of the form processing method and FIG. 8 is a sequence diagram showing the flow of overall processing in operation of the form processing method.

As shown in FIG. 7, if the OCR device 120 transmits assist information containing algorithm information to the form creation device 110 (S300), the form creation device 110 causes the layout generation unit 170 to generate the layout information that denotes a layout of the form 152 based on a user's input (S302). Then, in accordance with the input for printing the form 152, the data output unit 178 converts the layout information having the determined input region 184 into a printout-appropriate format and outputs it to the printer 130 (S304). The printer 130 prints the form 152 (S306). Then, the reference generation unit 174 generates reference data based on the layout information having the determined input region 184 (S308). The layout transmission unit 176 transmits the layout information and the reference data to the OCR device 120 (S310). The user writes a character etc. denoted by the reference data displayed, for example, on the display unit 160 and having the defined size 260a and content 260b.

After the information is written on the printed form 152, the scanner 140 reads the form 152 on which the information is written (S312) and transmits image data to the OCR device 120 (S314). The OCR processing unit 224 of the OCR device 120 performs OCR processing on the image data based on the layout information (S316). Then, the assist generation unit 226 generates reform information based on the results of the OCR processing and the reference data (S318). The assist transmission unit 230 transmits the reform information to the form creation device 110 (S320). The layout generation unit 170 in the form creation device 110 prompts the user for reformation based on the reform information so that the layout information may be modified (S322).

In operation, as shown in FIG. 8, in accordance with an input for printing of the form 152, the data output unit 178 in the form creation device 110 converts the layout information having the determined input region 184 into a printout-appropriate format and outputs it to the printer 130 (S340). The layout transmission unit 176 in the form creation device 110 transmits the layout information to the OCR device 120 (S342). The printer 130 prints the form 152 (S344). The layout information of the form 152 at this point in time is assumed to have been modified on the basis of the reform information already through the form processing method shown in FIG. 7.

Then, the user describes job-related information on the form 152 by handwriting, the form 152 is read by the scanner 140 (S346), and the read image data is transmitted to the OCR device 120 (S348). Then, the OCR processing unit 224 in the OCR device 120 performs OCR processing on the image data, to acquire the written information (S350). The layout of such image data is already modified in FIG. 7, thereby increasing the accuracy in OCR processing.

According to such a form processing method, both in testing shown in FIG. 7 and in operation shown in FIG. 8, it is possible to improve the accuracy in OCR processing by using layout information modified on the basis of reform information while mitigating work burdens on the user.

[First Variant]

Next, a description will be given of a variant of the described embodiment.

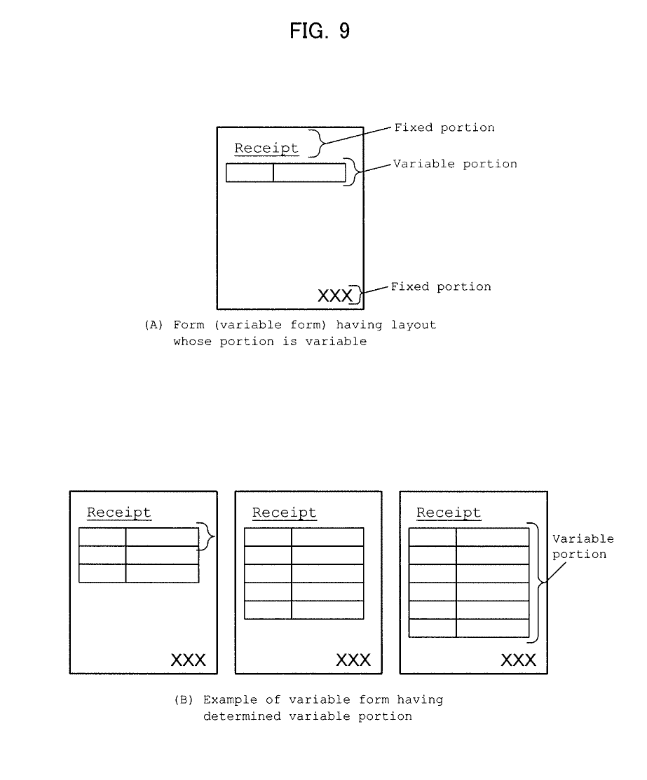

The first variant will be described with reference to processing such as exemplified in FIG. 9A on a form (hereinafter referred to as a variable form) having a layout whose portion is variable. As exemplified in FIG. 9A, the variable form includes a fixed portion having a fixed layout and a variable portion having a variable layout. In the variable portion, as exemplified in FIG. 9B, a quantity in an input region changes to thereby change a shape of an overall variable region. In a case where the variable portion constitutes an important portion as in the present example, those portions should preferably be used in OCR processing so that accuracy in OCR processing may be improved. It is to be noted that this holds true even more with the present example because the OCR processing in the present example includes a step of comparing layout image data and scanned image data to correct the scanned image data and a step of using the corrected image data to identify a character string etc. based on layout information.

Accordingly, if a variable form is designed in a form creation device 110, a form processing system 100 in the present variant accumulates the variable form printed by a printer 130 (that is, the variable form whose variable portion is determined) in an OCR device 120 and then performs OCR processing based on layout information and layout image data of the accumulated variable form. It is to be noted that although the present variant will be described with reference to a specific example of an aspect in which the layout information and the layout image data of a variable form whose variable portion is determined are accumulated in the OCR device 120, the layout information and the layout image data may be accumulated in an external server etc. so that those data would be provided to the OCR device 120 as necessary.

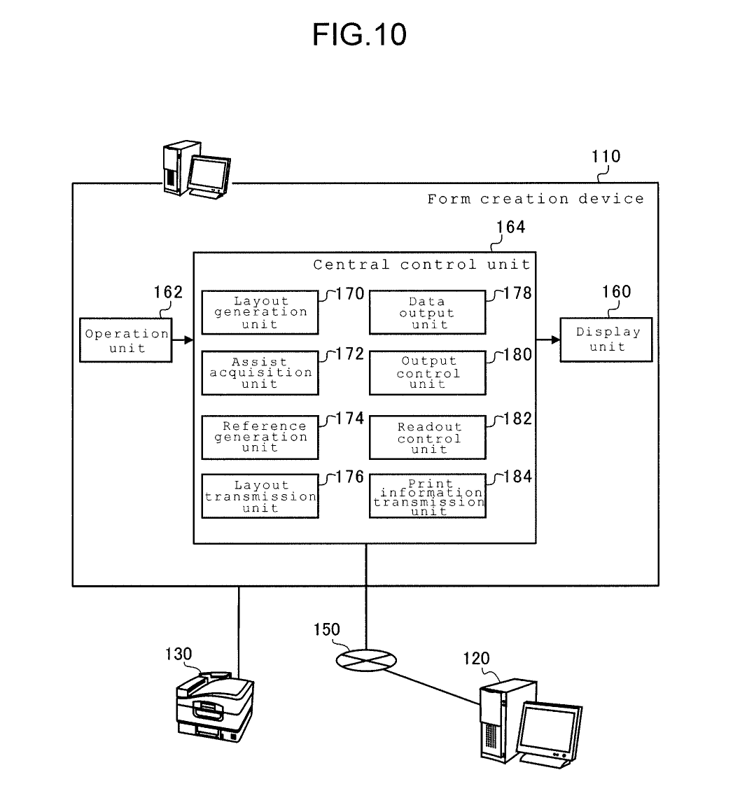

FIG. 10 is a functional block diagram showing a configuration of the form creation device 110 in the first variant. It is to be noted that identical reference numerals are given to the essentially identical components in FIGS. 10 and 2.

As exemplified in FIG. 10, the form creation device 110 has a configuration in which a print information transmission unit 184 is added to the form creation device in FIG. 2.

In the form creation device 110, if a variable form is printed by the printer 130, the print information transmission unit 184 transmits information about this print processing to the OCR device 120. The information about the print processing contains the number of printed sheets (number of printed copies), a print date (year, month, and day), and a printed quantity in the variable portion at the time of printing (varied quantity (variable quantity)). The print information transmission unit 184 in the present example transmits the number of sheets printed by the printer 130 and the print year, month, and day to the OCR device 120 in a state where they are correlated with a form ID of the printed variable form and the variable quantity on condition that data of the variable form is already output by a data output unit 178 to the printer 130. That is, if the variable portion in the variable form is determined, the print information transmission unit 184 in the present example transmits the number of printed sheets and the print year, month, and day to the OCR device in a state where they are correlated with the determined variable form.

On condition that a variable form is already printed by the printer 130, a layout transmission unit 176 in the first variant transmits all or part of layout information of the variable form whose variable portion is determined, to the OCR device 120. For example, the layout transmission unit 176 transmits image data that corresponds to the variable portion of the variable form to the OCR device 120 at timing different from that for the image data that corresponds to a fixed portion of the variable form. More specifically, on condition that layout information of the variable form is already generated by a layout generation unit 170, the layout transmission unit 176 transmits the layout information and the image data corresponding to the fixed portion of the variable form to the OCR device 120 and then, on condition that the variable form is already printed by the printer 130 based on the layout information of the variable form (that is, the variable portion of the variable form is already determined), transmits the layout information and the image data corresponding to the variable portion of the variable form to the OCR device 120. It is to be noted that the OCR device 120 combines the image data of the fixed portion and the image data of the variable portion to provide the image data of the form layout and combines the layout information of the fixed portion and the layout information of the variable portion to provide overall layout information.

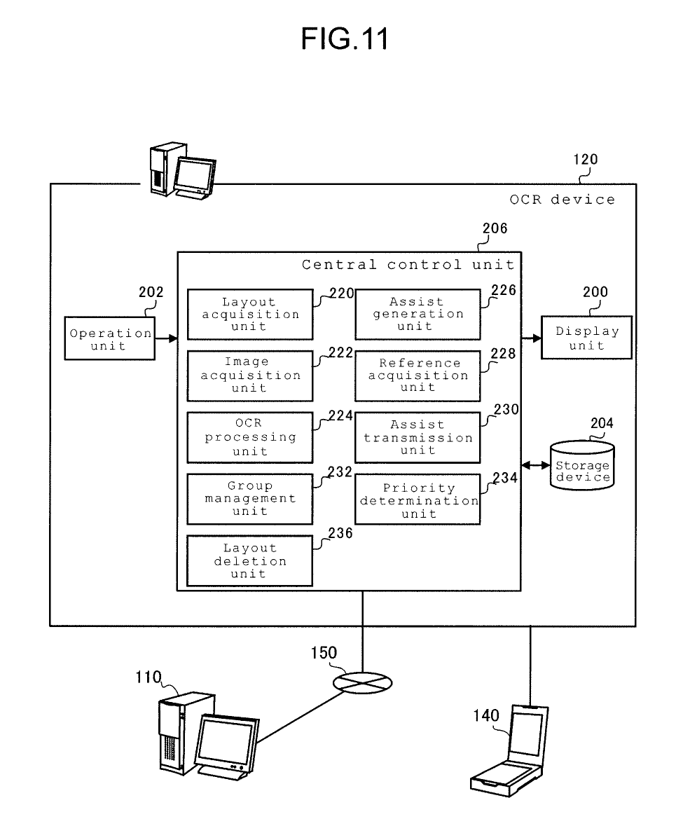

FIG. 11 is a functional block diagram showing a configuration of the OCR device 120 in the first variant. It is to be noted that identical reference numerals are given to the essentially identical components in FIGS. 11 and 5.

As exemplified in FIG. 11, the OCR device 120 in the present variant has a configuration in which a group management unit 232, a priority determination unit 234, and a layout deletion unit 236 are added to the OCR device in FIG. 5.

In the OCR device 120, the group management unit 232 manages image data of a plurality of layouts which have different variable portions and are generated on the basis of the same variable form (undetermined) in a state where it is correlated with identification information of the variable form (undetermined). That is, the group management unit 232 manages a plurality of layout information generated on the basis of the same variable form (undetermined) and having the different variable portions and image data thereof, as a group. The group management unit 232 in the present example stores layout information of a variable form having its variable portion determined and image data thereof in a storage device 204 in a state where they are correlated with a form ID of the variable form (undetermined), thereby managing the layout information and image data of a plurality of variable forms (determined) generated on the basis of the same variable form as a group.

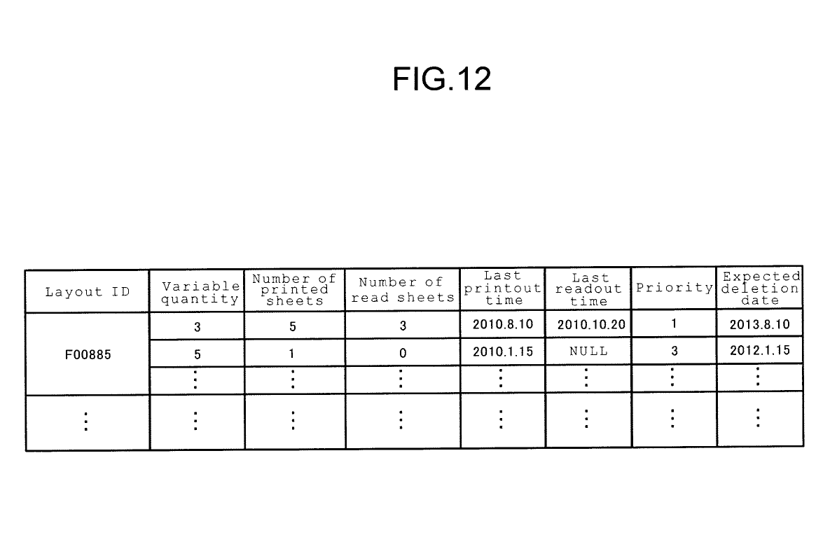

As exemplified in FIG. 12, the storage device 204 stores the layout information and the layout image data of a variable form having the determined variable portion in a state where they are correlated with the form ID of the variable form (undetermined) correlated by the group management unit 232, the variable quantity (numeral in the input region contained in the variable portion) identified on the basis of the layout information, the number of printed sheets and the last printout year, month, and day transmitted by the print information transmission unit 184, the number of read sheets and the last readout year, month, and day of each of the variable forms (determined) scanned by a scanner 140, an intra-group priority determined by a priority determination unit 234, and an expected deletion date determined by a layout deletion unit 236.

The priority determination unit 234 determines an intra-group priority of each of the determined variable forms based on the number of printed sheets of each of the variable forms (determined) printed on the basis of the same variable form (undetermined) and having the different variable portions. More specifically, the priority determination unit 234 determines the intra-group priority of each of the variable forms (determined) based on the number of printed sheets and the last printout year, month, and day of the variable forms (that is, variable forms having the different variable portions) belonging to the respective groups and the number of read sheets and the last readout year, month, and day of each of the variable forms. The priority determination unit 234 is configured such that, the larger the number of printed sheets is, the higher the priority is set; the more recent the last printout year is, the higher the priority is set; and the more recent the last readout year, month, and day is, the higher the priority is set. Further, the priority determination unit 234 estimates the number of the forms yet to be read based on the number of printed sheets and the number of read sheets of each of the variable forms (determined). The larger the estimated number of the forms yet to be read is, the higher the priority is set.

The layout deletion unit 236 determines the variable form (determined) to be excluded from group management based on the number of printed sheets of each of the variable forms (determined) printed on the basis of the same variable form (undetermined) and having the different variable portions and the number of read sheets of this variable form (determined) and deletes the determined variable form from the storage device 204. More specifically, the layout deletion unit 236 determines an expected deletion date for each of the variable forms to be excluded from group management based on the number of printed sheets of each of the variable forms (determined) printed on the basis of the same variable form (undetermined) and having the different variable portions and the last printout year, month, and day as well as the number of read sheets of each of the variable forms (determined) and the last readout year, month, and day and deletes the layout information and image data of the variable forms (determined) from the storage device 204 in accordance with the determined expected deletion date. The layout deletion unit 236 is configured such that, the larger the number of printed sheets is, the more the expected deletion date is delayed; the more recent the last printout year, month, and day is, the more the expected deletion date is delayed; and the more recent the last readout year, month, and day is, the more the expected deletion date is delayed. Further, the layout deletion unit 236 estimates the number of the forms yet to be read based on the printed sheets and the number of read sheets of each of the variable forms (determined). The smaller the estimated number of the forms yet to be read, the more the expected deletion date is advanced.

An OCR processing unit 224 in the first variant reads a form ID of a form 152 described in the form of a bar-code 182d etc. by using a position of a reference mark 182c in an image given by image data acquired by an image acquisition unit 222 as a reference and identifies a group based on the read form ID. Next, the OCR processing unit 224 compares image data of a layout belonging to the identified group and image data scanned by the scammer 140 in accordance with the priority determined by the priority determination unit 234 and, if any image data is found which has coincident characteristics more than prescribed conditions, corrects the scanned image data based on image data of the found layout and extracts character strings etc. from the corrected image data in accordance with layout information (position and attributes of the input region etc.) of the layout. The correction processing may be, for example, image tilt correction, image displacement correction, image distortion correction, etc.

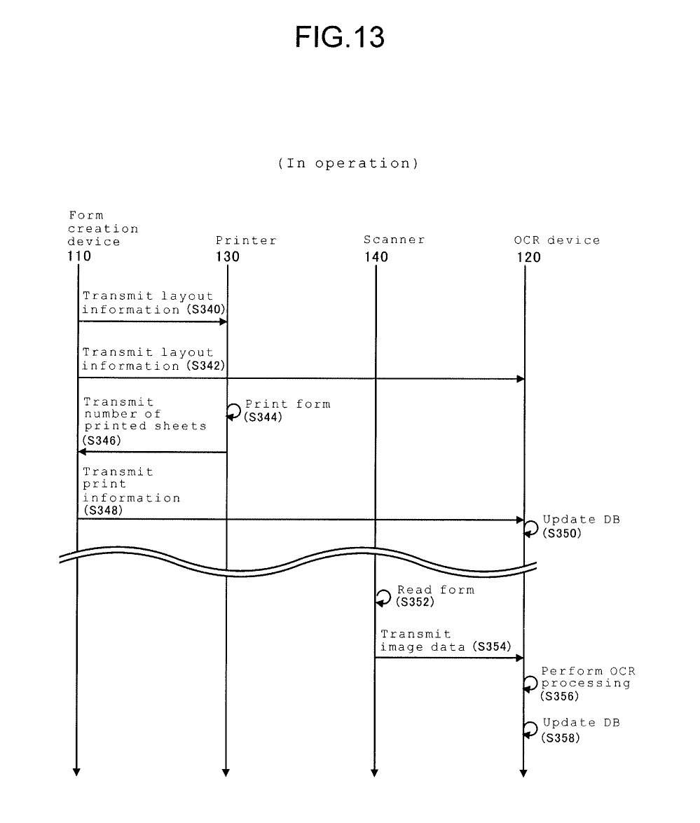

FIG. 13 is a sequence diagram showing a flow of overall processing during an operation in the first variant.

As shown in FIG. 13, in accordance with an operation input for printing a variable form, the data output unit 178 in the form creation device 110 converts layout information having a determined quantity in the input region into a format appropriate for printing out and outputs it to the printer 130 (S340). The layout transmission unit 176 in the form creation device 110 transmits the layout information and image data of the variable portion to the OCR device 120 (S342). It is to be noted that the layout information and image data of the fixed portion in the variable form is transmitted to the OCR device 120 beforehand.

The printer 130 prints the variable form (determined) (S344). If having completed print processing on the variable form, the printer 130 notifies the form creation device 110 of the number of printed sheets and the printout year, month, and day about the completed print processing (S346). The form creation device 110 transmits the number of printed sheets and the printout year, month, and day notified from the printer 130 as well as the form ID of and the variable quantity in the printed variable form to the OCR device 120 (S348). The OCR device 120 updates a database exemplified in FIG. 12 (S350). Specifically, the OCR device 120 adds the number of the newly printed variable forms and rewrites the last printout year, month, and day with those notified of. If the database is updated in such a manner, the priority determination unit 234 updates the priority of each of the variable forms and the layout deletion unit 236 updates the expected deletion date for the printed variable forms.

Then, after the user describes job-related information in the form by handwriting etc., the scanner 140 reads the written form (S352) and transmits read image data to the OCR device 120 (S354), whereupon the OCR processing unit 224 in the OCR device 120 performs OCR processing on the image data to acquire the written information (S356). Specifically, the OCR processing unit 224 identifies the form ID and compares image data of a group correlated with the identified form ID and scanned image data in accordance with the priority and, based on the image data in the variable form having coincident characteristics more than prescribed ones, corrects the scanned image data and acquires the written information from the corrected image data based on layout information correlated with this variable form.

If the OCR processing is completed, the OCR device 120 updates the database exemplified in FIG. 12 about the variable form corresponding to the scanned image data (S358). Specifically, the OCR device 120 adds the number of the read sheets and rewrites the last readout date with the present year, month, and day and also updates the expected deletion date.

By such a form processing method, it may be expected to improve accuracy in OCR processing on the variable forms. In particular, the variable portion in the variable form is often important as a target for OCR processing, so that the improvements in accuracy of the OCR processing on this portion is preferable.

Although the first variant has been described with reference to an aspect in which the form creation device 110 would generates image data of a variable form and transmit it to the OCR device 120, the present invention is not limited to it; for example, the OCR device 120 may generate image data of a plurality of layout having the different variable portions based on the layout information of an undetermined variable form and group a plurality of image data generated from the same layout information and store them in the storage device 204.

Although there has been hereinabove described the preferred embodiment of the present invention with reference to the accompanying drawings, of course, it should be appreciated that the present invention is not limited thereto. Accordingly, any and all modifications and variations which is conceivable to those skilled in the art should be considered to be within the scope of the present invention as defined in the appended claims.

It is to be noted that the steps in the form creation method in the present specification need not necessarily be performed in a time-series manner along the order described in the flowchart and may follow concurrent processing or subroutine-based processing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A form processing system comprising a form creation device and an OCR device, wherein the form creation device includes:
a layout generation unit that generates layout information denoting a layout of a form; and
a layout transmission unit that transmits the layout information generated to the OCR device, and
the OCR device includes:
a layout acquisition unit that acquires the layout information transmitted from the form creation device; and
an OCR processing unit that performs OCR processing on image data of the form read by a scanner, based on the layout information acquired.

2. The form processing system according to claim 1, wherein the OCR device further includes:
an assist generation unit that generates assist information assisting the generation of the layout information; and
an assist transmission unit that transmits the assist information to the form creation device,
the form creation device further includes an assist acquisition unit that acquires the transmitted assist information, and
the layout generation unit generates the layout information based on the acquired assist information.

3. The form processing system according to claim 2, wherein the assist information contains algorithm information about an algorithm which is used in an OCR processing unit in the OCR device.

4. The form processing system according to claim 2, wherein the assist generation unit generates reform information that denotes points to be reformed of the acquired layout information, based on results of the OCR processing, and
the assist information contains the reform information.

5. The form processing system according to claim 4, wherein the form creation device further includes a reference generation unit that generates reference data that provides a reference for comparison to the results of the OCR processing based on the generated layout information,
the layout transmission unit transmits the reference data to the OCR device,
the OCR device further includes a reference acquisition unit that acquires the transmitted reference data, and
the assist generation unit generates the reform information based on the acquired reference data and the results of the OCR processing.

6. The form processing system according to claim 1, wherein the form creation device further includes a data output unit that outputs the generated layout information to a printer,
the generated layout information contains variable information that defines a variable form in which an input region is variable, and
if the data output unit outputs the layout information having the determined input region in the variable information to the printer, the layout transmission unit transmits the layout information having the determined input region to the OCR device.

7. The form processing system according to claim 6, wherein if the data output unit outputs the layout information in which at least a shape of or a quantity in the input region is determined to the printer, the layout transmission unit transmits all or part of image data of the layout having this determined input region to the OCR device as at least one portion of the layout information.

8. The form processing system according to claim 7, wherein, on condition that the variable form having the layout whose portion is variable is already printed, the layout transmission unit transmits the image data that corresponds to the variable portion in the variable form to the OCR device and transmits the image data that corresponds to an invariable portion in the variable form to the OCR device at timing different from that for the image data that corresponds to the variable portion; and
the OCR processing unit combines the image data of the variable portion and the image data of the invariable portion in the variable form which are transmitted from the layout transmission unit separately from each other to be used in OCR processing.

9. The form processing system according to claim 7, wherein the OCR device further includes a group management unit that manages the image data of a plurality of the layouts generated on the basis of the same variable form and having the different variable portions in a state where they are correlated with the respective variable forms; and
the OCR processing unit identifies the variable form managed by the group management unit based on identification information of the variable forms and performs the OCR processing by using any one of the image data correlated with the identified variable form.

10. The form processing system according to claim 9, wherein the form creation device further includes a print information transmission unit that, if the variable form is printed, transmits information about the print processing to the OCR device; and
the OCR processing unit performs the OCR processing based on the information about the print processing transmitted by the print information transmission unit and the layout information acquired.

11. The form processing system according to claim 10, wherein the print information transmission unit transmits the number of printed variable forms in a state where it is correlated with the variable form having the determined variable portion;
the OCR device further includes a priority determination unit that determines a priority about a plurality of the image data managed by the group management unit based on the number of printed sheets transmitted by the print information transmission unit; and
the OCR processing unit compares each of the plurality of image data correlated with the variable form and the image data of the form read by the scanner in accordance the priority determined by the priority determination unit.

12. The form processing system according to claim 11, wherein the print information transmission unit transmits date information denoting a year, month, and day when the variable form is printed in a state where they are correlated with the variable form having the determined variable portion; and
the OCR device further includes a layout deletion unit that determines the image data to be deleted among the plurality of image data managed by the group management unit.

13. The form processing system according to claim 1, further comprising a printer and an image readout device, wherein the form creation device further includes:
an output control unit that controls, in the case of printing the form by the printer, this printer so that it may print under predetermined conditions; and
a readout control unit that specifies a method of operating the image readout device in the case of reading the form in this image readout device.

14. An OCR device comprising:
a layout acquisition unit that acquires layout information denoting a layout of a form transmitted from a form creation device that creates the form; and
an OCR processing unit that performs OCR processing on image data of the form read by a scanner, based on the layout information acquired.

15. The OCR device according to claim 14, further comprising a storage that stores, if the layout information of the variable form having the layout whose portion is variable is acquired by the layout acquisition unit, the image data of a plurality of the layouts generated on the basis of the layout information of this variable form and having the different variable portions, wherein the OCR processing unit performs the OCR processing by comparing a plurality of the image data stored in the storage and the image data of the variable form read by the scanner.

16. A non-transitory computer-readable medium storing thereon a computer program used in a computer, the computer program causing the computer to function as:
a layout acquisition unit that acquires layout information denoting a layout of a form transmitted from a form creation device that creates the form; and
an OCR processing unit that performs OCR processing on image data of the form read by a scanner, based on the layout information acquired.

17. A form creation device comprising:
a layout generation unit that generates layout information denoting a layout of a form; and
a layout transmission unit that transmits the layout information generated, to an OCR device that analyzes information written in the form.

18. A non-transitory computer-readable medium storing thereon a computer program used in a computer, the computer program causing the computer to function as:
a layout generation unit that generates layout information denoting a layout of a form; and
a layout transmission unit that transmits the layout information generated, to an OCR device that analyzes information written in the form.
